(19) United States
(12) Patent Application Publication
(10) Pub. No.: US 2005/0081065 A1
(43) Pub. Date: Apr. 14, 2005

(54) Method for securely delegating trusted platform module ownership

(76) Inventors: Ernie Brickell, Portland, OR (US); David W. Grawrock, Aloha, OR (US); James A. Sutton, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/686,343

(22) Filed: Oct. 14, 2003

(51) Int. Cl. H04L 9/32

(52) U.S. Cl. 713/202; 713/185

(57) ABSTRACT

Managing authorization tokens within a computer system may be accomplished by creating a master owner token indicating full ownership of a resource within the computer system by a management environment, creating at least one delegate owner token for a environment, communicating the delegate owner token to the environment and to the resource, and allowing access to the resource by the environment when the environment presents a valid delegate owner token to the resource. In one embodiment, the resource comprises a trusted platform module (TPM).

### BACKGROUND

1. Field

The present invention relates generally to trusted computing and, more specifically, to delegation of sets of permission for control of a trusted platform module in a computer system.

2. Description

A trusted platform module (TPM) is circuitry included within a computing system to support trusted computing. A TPM has been defined by the Trusted Computing Group (TCG) in the TCPA Main Specification 1.2, February 2002, and successive versions, available from the TCG. A TPM operates somewhat like a “smart card” on a motherboard of a computer system, such as a personal computer (PC), to provide various security functions to the system. There is only one TPM per system. The TPM typically includes a public/private key pair for cryptographic operations, can generate anonymous key pairs for use by other entities within the system, can perform encryption and decryption operations, can sign and verify data, and can establish a root of trust for the system. The TPM is typically connected to other components in the computing system by a low pin count bus, and is considered to be difficult to break into and affect its operations.

The owner of the TPM in a system controls the capabilities provided by the TPM. The owner is considered to be a person who purchased the system. Currently, TPM ownership is specified to the TPM by the possession of an ownership password, with only one ownership password per TPM/system. Once programmed into the TPM, only that password can enable the owner functionality of the TPM. If this password is forgotten and not retrievable (after being set in the TPM), then the TPM's owner functionality can no longer be used. However, if the password is stored on the system so that it does not have to be remembered by the owner, then it is vulnerable to misuse. The misuse scenario could occur because the password may be needed by multiple environments (e.g., one environment could change it and thus disable other environments). The owner/user of the system also needs to have the ability to install new environments that will need TPM owner capabilities, and should not be forced to remember the owner password to do so.

If a TPM owner password is set and then forgotten, no user can enable owner functionality for that TPM. The owner password would need to be reset using a hardware jumper (or some other means of physical presence of a user) and all secrets previously sealed by the TPM would be lost. If users write down the password to guard against this, then the password is susceptible to both loss and theft. Furthermore, for situations in which a centralized management of systems is desired (for example, in a corporate environment with an information technology (IT) department in charge of deploying and managing computing systems), it may not be desirable for the user of the system to have the privileges of controlling TPM ownership.

Accordingly, a system and method for controlling the delegation of TPM ownership and for managing TPM ownership without having to remember a password or token is needed.

### BRIEF DESCRIPTION OF THE DRAWINGS

The features and advantages of the present invention will become apparent from the following detailed description of the present invention in which:

FIG. 1 is a diagram of a computer system according to an embodiment of the present invention;

FIG. 2 is a diagram of functional components in a computer system according to an embodiment of the present invention; and

FIG. 3 is a flow diagram illustrating managing delegate owner tokens according to an embodiment of the present invention.

### DETAILED DESCRIPTION

An embodiment of the present invention is a method for permitting the owner/main user of a computer system to grant sets of permissions/delegations for control of a system resource (such as a TPM, for example) to different trusted entities. In at least one embodiment, this is accomplished while using limited space in the resource (e.g., TPM) and without requiring the owner to remember a password or token. Embodiments of the present invention permit a user/owner of a computer system to establish a list of acceptable environments (as defined herein), and then have those (and only those) environments automatically granted TPM ownership and management privileges on each subsequent boot of the system, without requiring further user interaction. The user/owner retains the ability to adjust the list, changing TPM privileges granted to an environment or revoking the privileges entirely. In one embodiment, a central authority (such as a corporate IT organization, for example) may set a master ownership token (MOT) and a list of acceptable environments. In one embodiment, users of the system need not know any of the passwords for environments to enable owner functionality. In another embodiment, the user may enter a password to enable owner functionality. Depending on the implementation, the user may enter a password for obtaining a MOT, but not for a delegate owner token. Additionally, the central authority does not need to become involved when environments (on the accepted list) are launched or added to the system.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

The following definitions may be helpful to understanding embodiments of the present invention.

TPM owner token: a piece of data (password, hash value, key, etc.) that is used to signify/establish TPM ownership (that is, anyone who knows or possesses the token can access owner functionality). There may be a master owner token (MOT) and one or more delegate owner tokens (DOTs). The MOT indicates full ownership, whereas a DOT indicates partial ownership. The tokens do not have to be of the same type (e.g., the MOT could be a key and the DOT a password).

Environment: a given set of hardware, firmware, and software for a computer system. Each software and firmware component (e.g., basic input/output system (BIOS), operating system (OS), OS boot loader, device drivers, and so on) may be hashed and the resulting value stored in a platform configuration register (PCR) on the computer system. Identifiers of hardware components may also be stored. The PCRs may be populated when the system is initialized to define a current set of environments for the system. The PCR values may be stored in the TPM. The set of PCR values define a given environment. In one embodiment, the initial trust measurement to compute one or more of the PCRs may be performed by a portion of Basic Input/Output System (BIOS) code. In one embodiment, the computation of one or more of the PCRs may be performed by the processor before control is given to a protected environment.

Protected environment: an execution environment (provided by hardware and software) that allows the software executing within it to be isolated and protected from all other software on the system regardless of that other software's privilege levels. In one embodiment, this environment may be an environment created by a secure virtual machine monitor (SVMM). A property that may be supported by a TPM is the ability to “seal” data (e.g., securely store data) to the environment. In some embodiments, this environment may include any software that the user has decided to trust.

Sealing: a process by which data is protected (encrypted with certain information) so that it can only be read/used in the same protected environment (i.e., by the same environment) to which it was sealed. Data that is sealed can be persisted to any storage system and cannot be viewed or changed (without detection) by any other software, including other protected environments. In one embodiment, data may be sealed by encrypting the data, along with the SHA-1 hashes of the environment (e.g., the PCR values), using a key stored only in the TPM. The TPM will only decrypt and allow access to the data if the environment hashes of the decrypting environment (e.g., PCR values) match those stored with the data.

As noted above, there may be multiple environments for a computer system. Hence, a mechanism is needed to handle the authorization token of a system-wide resource such as the TPM in such a way that processing by one environment will not interfere with processing by other environments. Embodiments of the present invention allow for multiple, mutually un-trusting environments, each at a peer level to each other. This allows a computing system to securely load and execute multiple operating environments (e.g., Linux, Windows, etc.), so that none of the environments can interfere with the access to resources needed by one of the other environments. In one embodiment, there is a correspondence between environments and tokens. An environment controls a token (master or delegate) if that environment is the only environment that is given access to that token. An environment can control a token by storing the token. If the environment is a protected environment, then the token can be stored using sealed storage. Alternatively, an environment can control a token by having the user input the token into the environment. Another embodiment is for the environment to store a first value, and the user to input a second value, and for the token to be computed from these two values. In one embodiment, this computation is a cryptographic hash of the second value exclusive or'ed with the first value (TOKEN=FirstValue XOR HASH(SecondValue)). If the owner token (or a value used in the computation of the owner token) is stored in a software environment, it is useful for the owner token to be sealed to that software environment for protection so that only that software environment can get access to the owner token.

A DOT (or MOT) may consist of two distinct pieces, a DOT-E (or MOT-E), which is the piece controlled by the environment, and a DOT-R (or MOT-R), which is the piece stored by the resource. If the DOT is a password, then the DOT-E and the DOT-R are the same. In this case, when the environment presents the DOT-E to the resource, this could be done by passing the password to the resource, or it could be done by a challenge-response protocol in which the password is not sent in the clear between the environment and the resource. In another embodiment, the DOT could consist of a public/private key pair. In this case, the DOT-R could be the public key, and the DOT-E could be the private key. In this case, when the environment presents the DOT-E to the resource, the resource could send some challenge to the environment, and the environment could perform some computation with the DOT-E private key which the DOT-R would verify.

A TPM has some functionality for which an owner token is required to authorize use of that functionality. Currently, a TPM has a single owner token that authorizes permission to perform any of the owner functionality for the computer system, including changing the owner token. In contrast, in embodiments of the present invention, a computer system includes ownership delegation capabilities. The system may have a master owner token and one or more delegate owner tokens. The master owner token (MOT) is given full owner functionality, including the ability to change a MOT. A delegate owner has partial owner functionality. Partial owner functionality may be any subset of full owner functionality. Typically, a delegate owner token would not authorize permission to modify the master owner token or the permissions allocated to the master owner token. Also, the DOT would not authorize permission to expand the permissions allocated to that DOT. Additionally, the DOT would not authorize permission to modify any other DOT, or to modify the permissions allocated to any other DOT. In one embodiment, there is a master environment (ME) that controls the master owner token. There is only one ME per system, which may be securely launched by the BIOS of the computer system in one embodiment. The ME controls the ability to set authorization tokens for delegate owner tokens. The delegate owner token (DOT) may authorize some subset of the owner's capabilities on the computer system. The delegate owner token may be controlled by a delegate environment other than the ME. Presentation of a DOT-E to a resource allows the resource to validate the requester and the requested activity. A delegate owner may be granted all owner functionality except for the ability to read/change either the MOT or any of the DOTs, or may be granted only subsets of owner functionality. The ME, as master owner, may disable one or all delegate owner tokens, or change the owner functionality granted to any delegate owner token. The ME may, in essence, control the capabilities (security and otherwise) of the delegate environments.

The resource may keep track of the DOT-Rs by means of an access control list. Each DOT-R that is authorized is kept on the list. It may be the case that the resource has limited space for storing the access control list. In this case, the ME can assist the resource in managing the access control list. The ME can put some set of DOT-Rs in the access control list of the resource. When some delegated environment whose DOT-R is not on the access control list requires access to the resource, the ME can determine whether the delegated environment should be allowed access, and if so, can if necessary, remove one DOT-R from the access control list, and replace it with the one requiring access.

The ME may control the MOT-E. Since the ME is managing the MOT-E for the system (and not the user), the MOT-E need not be a mnemonic or easily remembered data. Generally, the MOT-E may be any data indicating ownership. The ME may generate the MOT when the ME is first executed by the computer system. In the present system, the user does not need to know what the MOT-E is. The ME holds the MOT-E persistently and securely in such a way as to be accessible only to the ME's trusted environment. In one embodiment, the MOT-E is sealed in a secure storage in the computer system.

The ME may use the MOT to create a DOT for a selected delegated environment. In one embodiment, there may be multiple simultaneous delegate owner (environments), each having its own DOT created by the ME. The ME may program a resource, such as the TPM, with multiple DOT-Rs. The ME provides each DOT-E to a different delegated environment. In one embodiment, the ME provides the DOT-E to a delegated environment by sealing the DOT-E to that environment. Thus, any of the delegated environments may execute without having the ME re-program the TPM or re-seal the token.

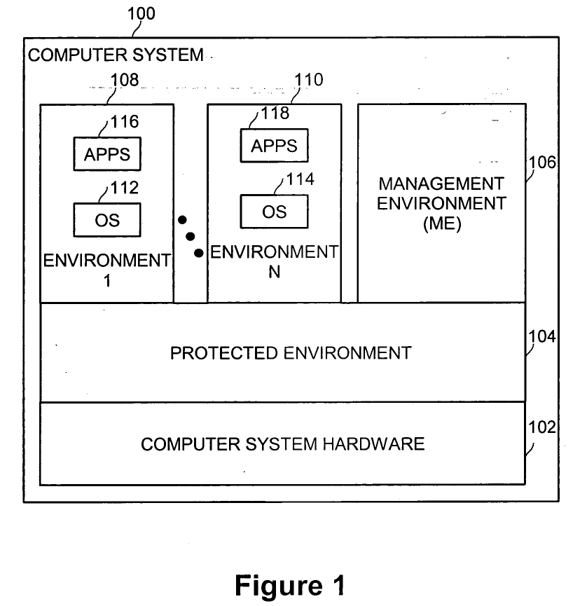

FIG. 1 is a diagram of a computer system 100 according to an embodiment of the present invention. Computer system 100 is representative of any processing system having at least one processor and a memory for storing instructions to be executed by the processor. The computer system includes hardware 102. The hardware may comprise conventional system components such as a processor, memories, buses, motherboard, interfaces, storage devices, input/output devices, etc., as well as a resource such as a TPM. Sitting “on top” of the hardware in the system stack shown in FIG. 1 may be a protected environment 104.

After system power on, the BIOS (not shown) may be started. The BIOS may then launch the management environment (ME) 106. The BIOS could launch the ME every time it executes, or it could launch the ME only when the user indicates that he or she wants to use the ME. The user may indicate to the BIOS that it wants a particular delegated environment to be able to launch. The BIOS could check to see if the DOT-R for that particular delegated environment was already in the access control list of the TPM. If it was, then the ME would not need to launch. However, if it was not, then the ME could launch so that the ME could modify the access control list of the TPM. Modifying the access control list may require user input. If it does, then the ME would need to bring up a user interface so that the user could give explicit permission. If the TPM did not already have the particular DOT-R in its access control list, then the ME would send the appropriate delegated owner token information to the TPM so that it would put it in its access control list. If there was no room for this DOT-R in the Resource, the ME would have to request that some DOT-R be removed from the Resource before adding the particular DOT-R. After the requested changes were made to the access control list of the TPM, the ME would exit.

After the BIOS has finished execution and the ME has either not executed, or has executed and existed, then the system could launch a delegated environment or could launch an OS which then launches a delegated environment.

When delegated environments 1 108 through N 110 are supported in the computer system, the ME 106 may generate a DOT for each delegated environment upon request. Each delegated environment 108, 110, may start an OS 112, 114 (e.g., Linux, Windows, etc.), and zero or more applications (Apps) 116, 118. Each delegated environment may desire some subset of ownership capabilities of the system when executing an OS and application programs. One of the capabilities may involve accessing a resource such as the TPM (not shown in FIG. 1). The DOT may be used to indicate ownership and related capabilities for a delegated environment.

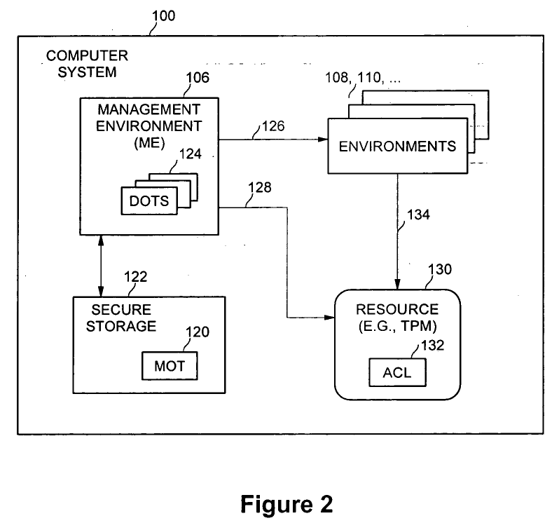

FIG. 2 is a diagram of functional components in a computer system according to an embodiment of the present invention. The ME 106 may generate a master owner token (MOT) 120 and store the MOT-E in a secure storage 122 in the computer system. The ME may then create a plurality of delegate owner tokens (DOTs) 124 as needed, one for each of a plurality of delegated environments 108, 110. The ME may communicate 126 a generated DOT-E to a particular delegated environment 108. The ME also communicates 128 the generated DOT-R for the delegated environment to a resource 130 on the computer system. In one embodiment, the resource comprises a TPM. The ME may access the resource because the ME has control of the master owner token of the system and may present the MOT-E 120 to the resource as part of, or prior to, the operation of communicating the DOT-R for the delegated environment. The resource may store the received DOT-R in a list called an access control list (ACL) 132. The ACL may comprise a list of DOT-Rs for delegated environments. When desiring some form of access to the resource, the delegated environment may communicate 134 the delegated environment's DOT-E to the resource. If the resource successfully validates the DOT, the resource may allow some form of access to the resource by the delegated environment. If not, the resource does not allow access. Only the ME may direct the resource to add or delete DOT-Rs from the ACL, because the ME is the only entity in the system that controls the MOT.

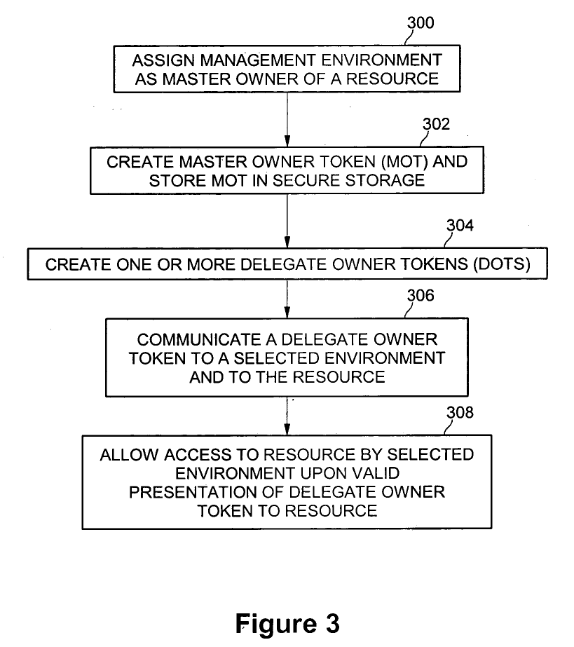

FIG. 3 is a flow diagram illustrating managing delegate owner tokens according to an embodiment of the present invention. When the computer system is started, the ME may also be started. At block 300, the ME may control the master owner token of a resource. In one embodiment, the resource comprises a TPM. In one embodiment, the entity assigning the master owner token may be a centralized organization such as an Information Technology (IT) department. At block 302, the ME creates the MOT and stores the MOT-E in a secure storage. For each delegated environment in the computer system that should be allowed access to the resource, the ME creates a DOT for each such delegated environment at block 304. The ME communicates the DOT-E to a selected delegated environment at block 306. The ME also communicates the DOT-R to the resource. In one embodiment, the resource stores the DOT-R in an access control list (ACL). When the delegated environment needs to access the resource, the resource allows access to the resource by the delegated environment when a valid DOT-E is presented to the resource by the delegated environment at block 308 and only to the extent indicated by the contents of the DOT. In one embodiment, the resource authenticates the DOT before allowing access.

Thus, embodiments of the present invention support multiple simultaneous mutually un-trusting delegate owners of a resource such as a TPM within a computer system. Any of the delegate owner (environments) may execute on the system without having the ME re-program the TPM or re-seal a DOT.

Although the operations may be described herein as a sequential process, some of the operations may in fact be performed in parallel or concurrently. In addition, in some embodiments the order of the operations may be rearranged without departing from the spirit of the invention.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A method of managing authorization tokens within a computer system comprising:
creating a master owner token indicating full ownership of a resource within the computer system by a management environment;
creating at least one delegate owner token for a delegated environment;
communicating the delegate owner token to the delegated environment and to the resource; and
allowing access to the resource by the delegated environment when the delegated environment presents a valid delegate owner token to the resource.

2. The method of claim 1, further comprising storing the master owner token in a secure storage within the computer system.

3. The method of claim 1, wherein the resource comprises a trusted platform module.

4. The method of claim 1, wherein the management environment assigns a delegate owner token to a delegated environment by sealing the delegate owner token to the delegated environment.

5. The method of claim 1, wherein the master owner token indicates the management environment can change at least one of the master owner token and a delegate owner token.

6. The method of claim 1, further comprising launching the management environment before launching the delegated environment.

7. The method of claim 1, further comprising storing the delegate owner token in an access control list in the resource.

8. The method of claim 1, further comprising removing, by the management environment, a delegate owner token from the access control list and adding a different delegate owner token to the access control list.

9. An article comprising: a storage medium having a plurality of machine readable instructions, wherein when the instructions are executed by a processor, the instructions provide for managing authorization tokens within a computer system by
creating a master owner token indicating full ownership of a resource within the computer system by an administrative environment;
creating at least one delegate owner token for a environment;
communicating the delegate owner token to the environment and to the resource; and
allowing access to the resource by the environment when the environment presents a valid delegate owner token to the resource.

10. The article of claim 9, further comprising instructions for storing the master owner token in a secure storage within the computer system.

11. The article of claim 9, wherein the resource comprises a trusted platform module.

12. The article of claim 9, wherein the management environment assigns a delegate owner token to a delegated environment by sealing the delegate owner token to the delegated environment.

13. The article of claim 9, wherein the master owner token indicates the management environment can change at least one of the master owner token and a delegate owner token.

14. The article of claim 9, further comprising instructions for launching the management environment before launching the environment.

15. The article of claim 9, further comprising instructions for storing the delegate owner token in an access control list in the resource.

16. The article of claim 9, further comprising instructions for removing, by the management environment, a delegate owner token from the access control list and adding a different delegate owner token to the access control list.

17. A computer system comprising:
a plurality of environments;
a management environment to create a master owner token indicating full ownership of a resource within the computer system, to create a plurality of delegate owner tokens indicating partial ownership of the resource, and to communicate a selected one of the delegate owner tokens to a selected one of the plurality of environments and to the resource;
wherein the resource stores delegate owner tokens received from the management environment and allows access to the resource by the selected environment when a valid delegate owner token is presented to the resource by the selected environment.

18. The computer system of claim 17, further comprising a secure storage to store the master owner token.

19. The computer system of claim 17, wherein the resource comprises a trusted platform module.

20. The computer system of claim 19, wherein the trusted platform module comprises an access control list for storing the delegate owner tokens received from the management environment.
